(19) United States
(12) Patent Application Publication
(10) Pub. No.: US 2026/0204631 A1
(43) Pub. Date: Jul. 16, 2026

(54) BATTERY

(71) Applicant: Panasonic Intellectual Property Management Co., Ltd., Osaka (JP)

(72) Inventor: Eiichi KOGA, Hokkaido (JP)

(21) Appl. No.: 19/451,354

(22) Filed: Jan. 16, 2026

Related U.S. Application Data
(63) Continuation of application No. PCT/JP2024/021942, filed on Jun. 17, 2024.

(30) Foreign Application Priority Data
Jul. 21, 2023 (JP) 2023-119501

(51) Int. Cl. H01M 10/0562

(52) U.S. Cl. CPC H01M 10/0562

(57) ABSTRACT

A battery according to the present disclosure includes a first electrode layer, a second electrode layer, and an electrolyte layer. The battery satisfies at least one configuration selected from the group consisting of the following (I) and (II):
(I) at least one selected from the group consisting of the first electrode layer, the second electrode layer, and the electrolyte layer includes an Al halide; and
(II) the battery further includes a side surface layer, the side surface layer being disposed on a side surface of at least one layer selected from the group consisting of the first electrode layer, the second electrode layer, and the electrolyte layer, the side surface layer including an Al halide.

The Al halide is represented by the following composition formula (1):

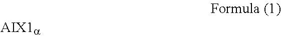

in the composition formula (1), the X1 is at least one selected from the group consisting of F, Cl, Br, and I, and the α satisfies 2.95≤α≤3.05.

This application is a continuation of PCT/JP2024/021942 filed on Jun. 17, 2024, which claims foreign priority of Japanese Patent Application No. 2023-119501 filed on Jul. 21, 2023, the entire contents of both of which are incorporated herein by reference.

### BACKGROUND OF THE INVENTION

### 1. Field of the Invention

The present disclosure relates to a battery.

### 2. Description of Related Art

WO 2023/037817 discloses a battery including a solid electrolyte coating an active material, the solid electrolyte including Li, Ti, M, and F, where M is at least one selected from the group consisting of Ca, Mg, Al, Y, and Zr. In WO 2023/037817, the above solid electrolyte is included in a coating layer coating the active material.

### SUMMARY OF THE INVENTION

In conventional techniques, there has been a demand for high-reliability batteries. In view of this, the present disclosure provides a battery having enhanced mechanical strength and thus enhanced reliability.

A battery of the present disclosure includes:
a first electrode layer;
a second electrode layer; and
an electrolyte layer disposed between the first electrode layer and the second electrode layer, wherein
the battery satisfies at least one configuration selected from the group consisting of the following (I) and (II):
(I) at least one selected from the group consisting of the first electrode layer, the second electrode layer, and the electrolyte layer includes an Al halide; and
(II) the battery further includes a side surface layer, the side surface layer being disposed on a side surface of at least one layer selected from the group consisting of the first electrode layer, the second electrode layer, and the electrolyte layer, the side surface layer including an Al halide, and
the Al halide is represented by the following composition formula (1):

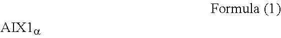

in the composition formula (1), the X1 is at least one selected from the group consisting of F, Cl, Br, and I, and the α satisfies 2.95≤α≤3.05.

The present disclosure can provide a battery having enhanced reliability.

### BRIEF DESCRIPTION OF THE DRAWINGS

FIG. 1 is a cross-sectional view and a plan view schematically showing the configuration of a battery 1000 according to Embodiment 1.

FIG. 2 is a cross-sectional view and a plan view schematically showing the configuration of a battery 1100 according to Embodiment 2.

FIG. 3 is a cross-sectional view and a plan view schematically showing the configuration of a battery 1200 according to Embodiment 3.

FIG. 4 is a cross-sectional view and a plan view schematically showing the configuration of a battery 1300 according to Embodiment 4.

FIG. 5 is a cross-sectional view and a plan view schematically showing the configuration of a battery 1400 according to Embodiment 5.

FIG. 6 is a cross-sectional view and a plan view schematically showing the configuration of a battery 1500 according to Embodiment 6.

### DETAILED DESCRIPTION

Embodiments of the present disclosure are described in detail below with reference to the drawings.

The embodiments described below are each presented as a general or specific example. The numerical values, shapes, materials, arrangement positions and connection manners of constituents, manufacturing steps, the order of the manufacturing steps, and the like indicated in the embodiments below are merely illustrative and should not be construed as limiting the present disclosure. Furthermore, among the constituents in the embodiments below, those not recited in the independent claim representing the broadest concept are described as optional constituents.

In the present specification, terms such as “parallel” representing relationships between constituents, terms such as “rectangular” representing the shapes of constituents, and numerical ranges are not expressions limited to their strict meanings, but are intended to encompass substantial equivalents including, for example, even variations of several percent.

The drawings are schematic diagrams and are not necessarily strictly accurate. Accordingly, for example, the scales and the like in the drawings are not necessarily consistent. In the drawings, substantially identical constituents are denoted by the same reference numerals, and redundant descriptions thereof are omitted or simplified.

In the present specification and the drawings, the x axis, the y axis, and the z axis indicate the three axes in a three-dimensional orthogonal coordinate system. In the embodiments, the z-axis direction is defined as the thickness direction of the battery. Furthermore, in the present specification, the “thickness direction” refers to a direction perpendicular to the plane along which the layers in the battery are stacked, unless specifically stated otherwise.

In the present specification, the term “plan view” means viewing the battery along the stacking direction of the layers in the battery. In the present specification, the “thickness” refers to the length of the battery and the layers in the stacking direction.

In the present specification, for the battery and the layers, the “side surface” refers to the surface extending along the stacking direction of the layers in the battery, and the “principal surface” refers to the surface other than the side surface, unless specifically stated otherwise.

In the present specification, “in” and “out” in the terms “inner”, “outer”, and the like respectively indicate the side closer to the center of the battery and the side closer to the periphery of the battery when the battery is viewed along the stacking direction of the layers in the battery.

In the present specification, the terms “upper” and “lower” in the battery configuration respectively do not mean being in the upward direction (vertically above) and being in the downward direction (vertically below) in absolute spatial reference, but are used as the terms defined by the relative positional relationship based on the stacking order in the stacked structure. Furthermore, the terms “upper” and “lower” are applied not only in the case where two constituents are disposed with a space therebetween and another constituent is present between the two constituents, but also in the case where two constituents are disposed in close and direct contact with each other.

### Embodiment 1

A battery according to Embodiment 1 is described below.

The battery according to Embodiment 1 includes a first electrode layer, a second electrode layer, and an electrolyte layer. The electrolyte layer is disposed between the first electrode layer and the second electrode layer.

The battery according to Embodiment 1 satisfies at least one configuration selected from the group consisting of the following (I) and (II):
(I) at least one selected from the group consisting of the first electrode layer, the second electrode layer, and the electrolyte layer includes an Al halide; and
(II) the battery according to Embodiment 1 further includes a side surface layer, the side surface layer being disposed on a side surface of at least one layer selected from the group consisting of the first electrode layer, the second electrode layer, and the electrolyte layer, the side surface layer including an Al halide.

The above Al halide is represented by the following composition formula (1):

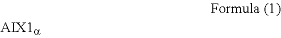

in the above composition formula (1), X1 is at least one selected from the group consisting of F, Cl, Br, and I, and α satisfies 2.95≤α≤3.05.

In the above composition formula (1), α may be 3. That is, the above Al halide may be represented by AlX1₃.

The Al halide in which X1 is, for example, Cl, Br, or I has a relatively low melting point and is soft, and accordingly can act effectively as a binder and a stress-absorbing material. Furthermore, the Al halide in which X1 is, for example, F has a relatively high melting point and is hard, and accordingly can act effectively as a reinforcing material. These actions of the Al halide can be adjusted by selecting the halogen element X1 in the Al halide. Accordingly, a plurality of halogen elements may be incorporated depending on the desired properties so that an enhancement in mechanical strength by stress absorption and an enhancement in mechanical strength by reinforcement can be effectively combined, and a halogen element may be selected for the purpose of either enhancing mechanical strength by stress absorption or enhancing mechanical strength by reinforcement. Accordingly, by including the Al halide, the battery according to Embodiment 1 can have effectively enhanced strength against stress caused by external impact, thermal shock, and expansion and contraction of the battery resulting from charging and discharging or heating and cooling. Therefore, the battery according to Embodiment 1 can have enhanced mechanical strength and thus enhanced reliability.

The above effects can be achieved when the battery according to Embodiment 1 satisfies any of the above configurations (I) and (II). For example, when the above configuration (I) is satisfied, it is possible to enhance the strength of the electrode layer and/or the electrolyte layer, each of which is a power-generating element of the battery. This enhances the reliability of the battery. Furthermore, when the above configuration (II) is satisfied, it is possible to effectively suppress, by the side surface layer including the Al halide, structural defects that tend to occur at a side surface of the battery serving as an initiation site (i.e., cracking or peeling originating from a side surface) and in which the influence of external impact and thermal shock tends to become apparent. This enhances the reliability of the battery.

A configuration example of the battery according to Embodiment 1 is described below. The configuration example described below is an example in which the battery according to Embodiment 1 satisfies the above configuration (I) and the electrolyte layer is a solid electrolyte layer. That is, the battery in the configuration example described below is, for example, an all-solid-state battery.

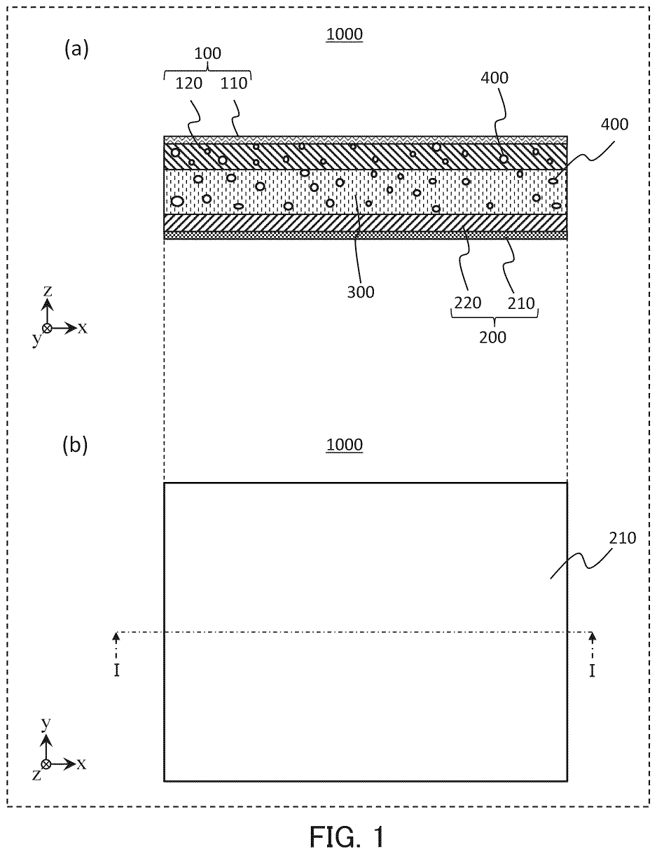

FIG. 1 is a cross-sectional view and a plan view schematically showing the configuration of a battery 1000 according to Embodiment 1.

FIG. 1(a) is a cross-sectional view of the battery 1000 according to Embodiment 1. FIG. 1(b) is a plan view of the battery 1000 according to Embodiment 1 as viewed from below in the z-axis direction. In FIG. 1(a), a cross section at the position indicated by line I-I in FIG. 1(b) is shown.

As shown in FIG. 1, the battery 1000 includes a first electrode layer 100, a second electrode layer 200 disposed parallel to and opposite to the first electrode layer 100, and a solid electrolyte layer 300 positioned between the first electrode layer 100 and the second electrode layer 200. In other words, the battery 1000 is a battery including the first electrode layer 100, the solid electrolyte layer 300, and the second electrode layer 200 in this order in the stacking direction. For example, the first electrode layer 100 and the solid electrolyte layer 300 include an Al halide. The Al halide included may be a particulate Al halide (hereinafter referred to as “Al halide particles”) 400. As described above, the battery 1000 is, for example, an all-solid-state battery.

The first electrode layer 100 includes a first current collector 110 and a first active material layer 120. For example, the first active material layer 120 includes the Al halide particles 400. Furthermore, the second electrode layer 200 includes a second current collector 210 and a second active material layer 220. The solid electrolyte layer 300 includes the Al halide particles 400, is positioned between the first active material layer 120 and the second active material layer 220, and is in contact with both the first active material layer 120 and the second active material layer 220. In the battery 1000 shown in FIG. 1, the Al halide particles 400 are included only in the first electrode layer 100 and the solid electrolyte layer 300. However, the Al halide particles 400 may also be included in the second electrode layer 200.

In the example shown in FIG. 1, the first current collector 110, the first active material layer 120, the solid electrolyte layer 300, the second active material layer 220, and the second current collector 210 each have an approximately rectangular shape in plan view. However, in the battery according to Embodiment 1, the shape of each of these constituents is not limited to a rectangular shape.

Furthermore, in the example shown in FIG. 1, the current collector 110, the first active material layer 120, the solid electrolyte layer 300, the second active material layer 220, and the second current collector 210 have the same size and coincident outlines in plan view; however, the configuration is not limited thereto. For example, the first active material layer 120 may be smaller than the second active material layer 220. The first active material layer 120 and the second active material layer 220 may be smaller than the solid electrolyte layer 300. For example, a portion of the solid electrolyte layer 300 may be in contact with at least one of the first current collector 110 and the second current collector 210.

In the battery 1000 according to Embodiment 1, for example, the first electrode layer 100 is the positive electrode layer, and the second electrode layer 200 is the negative electrode layer. In this case, specifically, the first current collector 110 is the positive electrode current collector, and the first active material layer 120 is the positive electrode active material layer. Furthermore, the second current collector 210 is the negative electrode current collector, and the second active material layer 220 is the negative electrode active material layer.

A configuration may be employed in which the first electrode layer 100 is the negative electrode and the second electrode layer 200 is the positive electrode. Specifically, a configuration may be employed in which the first current collector 110 is the negative electrode current collector and the first active material layer 120 is the negative electrode active material layer. A configuration may be employed in which the second current collector 210 is the positive electrode current collector and the second active material layer 220 is the positive electrode active material layer.

In the following description, the positive electrode active material layer and the negative electrode active material layer may be collectively referred to simply as the “active material layer”. Furthermore, the positive electrode current collector and the negative electrode current collector may be collectively referred to simply as the “current collector”.

### (Current Collector)

The current collector is formed of a conductive material. Examples of the material of the current collector include stainless steel, nickel (Ni), aluminum (Al), iron (Fe), titanium (Ti), copper (Cu), palladium (Pd), gold (Au), platinum (Pt), and an alloy of two or more of these. As the current collector, foil-shaped, plate-shaped, or mesh-shaped bodies formed of these materials can be used.

The material of the current collector can be selected in view of the manufacturing process, operating temperature, operating pressure, operating potential of the battery to which the current collector is subjected, or conductivity. Furthermore, the material of the current collector can be selected depending also on the tensile strength or heat resistance required for the battery.

The current collector may be a high-strength electrolytic copper foil or a cladding material obtained by laminating dissimilar metal foils.

The current collector has a thickness of, for example, 10 μm or more and 100 μm or less.

The surface of the current collector may be processed into a rough surface having irregularities in order to enhance adhesion to the active material layer.

An adhesive component, such as an organic binder, may be applied to the surface of the current collector. Furthermore, insulating particles, conductive particles, or semiconductive particles may adhere to the surface of the current collector. These configurations strengthen the bonding property at the interface between the current collector and another layer (e.g., the active material layer), enabling enhancements in the mechanical and thermal reliability, cycle characteristics, and the like of the battery 1000.

### (Active Material Layer)

The first active material layer 120 is, for example, a positive electrode active material layer. The first active material layer 120 is sandwiched between the first current collector 110 and the solid electrolyte layer 300. The first active material layer 120 may be in contact with the principal surface of the first current collector 110. The first active material layer 120 may be in contact with the principal surface of the solid electrolyte layer 300.

The second active material layer 220 is, for example, a negative electrode active material layer. The second active material layer 220 is sandwiched between the second current collector 210 and the solid electrolyte layer 300. The second active material layer 220 may be in contact with the principal surface of the second current collector 210. The second active material layer 220 may be in contact with the principal surface of the solid electrolyte layer 300.

The positive electrode active material layer includes a positive electrode active material.

The positive electrode active material refers to a material that intercalates or deintercalates metal ions, such as lithium (Li) ions or magnesium (Mg) ions, into or from the crystal structure at a higher potential than the potential of the negative electrode and is accordingly oxidized or reduced. The positive electrode active material can be selected as appropriate depending on the battery type, and a known positive electrode active material can be used.

The positive electrode active material is, for example, a compound including lithium and a transition metal element. The compound is, for example, an oxide including lithium and a transition metal element or a phosphate compound including lithium and a transition metal element.

Examples of the oxide including lithium and a transition metal element include a lithium-nickel composite oxide, such as LiNiₓM₁₋ₓO₂ (where M is at least one selected from the group consisting of Co, Al, Mn, V, Cr, Mg, Ca, Ti, Zr, Nb, Mo, and W, and 0<x≤1 is satisfied); a layered oxide, such as lithium cobalt oxide (LiCoO₂) and lithium nickel oxide (LiNiO₂); and a lithium manganese oxide (e.g., LiMn₂O₄, Li₂MnO₃, and LiMnO₂) having a spinel structure.

An example of the phosphate compound including lithium and a transition metal element is lithium iron phosphate (LiFePO₄) having an olivine structure.

As the positive electrode active material, sulfur (S) and a sulfide, such as lithium sulfide (Li₂S), may be used. In this case, particles of the positive electrode active material may be subjected to coating with or addition of lithium niobate (LiNbO₃) or the like.

The positive electrode active material may be only one of these materials or a combination of two or more of these materials.

The positive electrode active material layer may include the Al halide. This enables the Al halide to absorb stress caused by expansion and contraction of the positive electrode active material resulting from external stress or charging and discharging and by thermal expansion and contraction of the positive electrode active material resulting from thermal cycling. Accordingly, the mechanical strength of the positive electrode active material layer can be enhanced, thereby suppressing the occurrence of defects. Furthermore, the compatibility of the positive electrode active material layer with the solid electrolyte layer 300 (e.g., expansion and contraction properties during charging and discharging or expansion and contraction properties during thermal cycling) can be adjusted. As shown in FIG. 1, the Al halide may be the Al halide particles 400.

To enhance lithium-ion conductivity or electronic conductivity, the positive electrode active material layer, which includes the positive electrode active material, may include a material other than the positive electrode active material and the Al halide. That is, the positive electrode active material layer may be a mixture layer. Examples of the material include a solid electrolyte, such as an inorganic solid electrolyte or a sulfide-based solid electrolyte, a conductive additive, such as acetylene black, and a binder, such as polyethylene oxide or polyvinylidene fluoride. The solid electrolyte may be, for example, a halide solid electrolyte. Examples of the halide solid electrolyte included in the positive electrode active material layer are the same as the later-described examples of a halide solid electrolyte included in the solid electrolyte layer 300.

By mixing the positive electrode active material with other additive materials, such as a solid electrolyte, in a predetermined ratio to form the positive electrode active material layer, it is possible to enhance the ionic conductivity in the positive electrode active material layer and to enhance the electronic conductivity in the positive electrode active material layer as well.

The positive electrode active material layer may have a thickness of, for example, 5 μm or more and 300 μm or less.

The negative electrode active material layer includes a negative electrode active material.

The negative electrode active material layer is a layer that is composed primarily of a negative electrode material, such as a negative electrode active material.

The negative electrode active material refers to a material that intercalates or deintercalates metal ions, such as lithium (Li) ions or magnesium (Mg) ions, into or from the crystal structure at a lower potential than the potential of the positive electrode and is accordingly oxidized or reduced. The negative electrode active material can be selected as appropriate depending on the battery type, and a known negative electrode active material can be used.

Examples of the negative electrode active material include a carbon material, such as natural graphite, artificial graphite, a graphite carbon fiber, or resin baked carbon, and an alloy-based material to be mixed with a solid electrolyte. Examples of the alloy-based material include a lithium alloy, such as LiAl, LiZn, Li₃Bi, Li₃Cd, Li₃Sb, Li₄Si, Li_{4.4}Pb, Li_{4.4}Sn, Li_{0.17}C, or LiC₆, an oxide of lithium and a transition metal element, such as lithium titanate (Li₄Ti₅O₁₂), and a metal oxide, such as zinc oxide (ZnO) or silicon oxide (SiOₓ).

The negative electrode active material may be only one of these materials or a combination of two or more of these materials.

To enhance lithium-ion conductivity or electronic conductivity, the negative electrode active material layer, which includes the negative electrode active material, may include a material other than the negative electrode active material. Examples of the material include a solid electrolyte, such as an inorganic solid electrolyte or a sulfide-based solid electrolyte, a conductive additive, such as acetylene black, and a binder, such as polyethylene oxide or polyvinylidene fluoride. The solid electrolyte may be, for example, a halide solid electrolyte. Examples of the halide solid electrolyte included in the negative electrode active material layer are the same as the later-described examples of a halide solid electrolyte included in the solid electrolyte layer 300.

The negative electrode active material layer may have a thickness of, for example, 5 μm or more and 300 μm or less.

The negative electrode active material layer may include the Al halide, as with the positive electrode active material layer described above.

### (Solid Electrolyte Layer)

The solid electrolyte layer 300 includes a solid electrolyte.

The solid electrolyte layer 300 includes the solid electrolyte, for example, as its main component. Here, the main component refers to the component having the highest mass content in the solid electrolyte layer 300. As described above, the solid electrolyte layer 300 includes, for example, the Al halide. The Al halide is, for example, the Al halide particles 400.

The solid electrolyte should be any known solid electrolyte for batteries that has ionic conductivity. The solid electrolyte included in the solid electrolyte layer 300 can be, for example, a solid electrolyte that conducts metal ions, such as lithium ions or magnesium ions.

The solid electrolyte can be a sulfide solid electrolyte, an oxide solid electrolyte, or a halide solid electrolyte.

Examples of the sulfide solid electrolyte include those based on Li₂S—P₂S₅, Li₂S—SiS₂, Li₂S—B₂S₃, Li₂S—GeS₂, Li₂S—SiS₂—LiI, Li₂S—SiS₂—Li₃PO₄, Li₂S—Ge₂S₂, Li₂S—GeS₂—P₂S₅, and Li₂S—GeS₂—ZnS.

Examples of the oxide solid electrolyte include a lithium-containing metal oxide, a lithium-containing metal nitride, lithium phosphate (Li₃PO₄), and a lithium-containing transition metal oxide. Examples of lithium-containing metal oxides include Li₂O—SiO₂ and Li₂O—SiO₂—P₂O₅. Examples of lithium-containing metal nitrides include LiₓP_{y}O_{1-z}N_{z} (0<z≤1). Examples of lithium-containing transition metal oxides include lithium titanium oxide.

The halide solid electrolyte is, for example, a solid electrolyte including Li, at least one element selected from the group consisting of metalloid elements and metal elements other than Li, and a halogen element.

The “metalloid elements” refer to B, Si, Ge, As, Sb, and Te. The “metal elements” refer to all the elements included in Groups 1 to 12 of the periodic table (except hydrogen) and all the elements included in Groups 13 to 16 of the periodic table (except B, Si, Ge, As, Sb, Te, C, N, P, O, S, and Se).

It is desirable that the halide solid electrolyte be substantially free of sulfur. “The halide solid electrolyte is substantially free of sulfur” means that the halide solid electrolyte does not include sulfur as its constituent element, except for sulfur unavoidably introduced as an impurity. In this case, the sulfur introduced as an impurity into the halide solid electrolyte is, for example, 1 mol % or less. It is more desirable that the halide solid electrolyte be free of sulfur. The sulfur-free solid electrolyte does not generate hydrogen sulfide when exposed to the atmosphere, and is accordingly excellent in safety.

The solid electrolyte layer 300 includes, for example, a halide solid electrolyte. According to this configuration, the halide solid electrolyte included in the solid electrolyte layer 300 and the Al halide particle 400 have thermal expansion characteristics that tend to match each other because both are halides. Accordingly, the bonding interface between the Al halide particle 400 and the halide solid electrolyte becomes firm. This suppresses the occurrence of structural defects caused by peeling at the bonding interface between the Al halide particle 400 and the halide solid electrolyte that results from thermal shock or thermal cycling. That is, according to this configuration, the effectiveness of the Al halide against thermal shock and thermal cycling is further enhanced. Consequently, the reliability of the battery 1000 according to Embodiment 1 is further enhanced.

The halide solid electrolyte may include Al. According to this configuration, the solid electrolyte layer 300 including a solid electrolyte having a high ionic conductivity of, for example, 1 μS/cm or more, can be obtained. Furthermore, owing to the presence of Al, which is included in both the Al halide and the halide solid electrolyte in common, the Al halide and the solid electrolyte firmly bond to each other, facilitating formation of an integrated bonding interface. Accordingly, when the Al halide is included in the solid electrolyte layer, the Al halide can coexist with the solid electrolyte within the solid electrolyte layer, in a stable manner (e.g., with no formation of fine defects in the surrounding region). Therefore, a battery having further enhanced reliability can be obtained. Furthermore, since the halide solid electrolyte including Al has atmospheric stability and excellent heat resistance up to about 700° C. to about 800° C., even when AlF₃, which has a high melting point, is incorporated as the Al halide, the effect of incorporating AlF₃ can be obtained up to high temperatures.

The halide solid electrolyte may include a first halide solid electrolyte including a crystalline phase represented by the following composition formula (2):

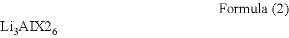

in the composition formula (2), X2 is at least one selected from the group consisting of F, Cl, Br, and I.

The first halide solid electrolyte has a high ionic conductivity of, for example, 1 μS/cm or more, atmospheric stability, and heat resistance. Accordingly, owing to the inclusion of the first halide solid electrolyte, the ionic conductivity and reliability of the solid electrolyte layer 300 are enhanced. The crystalline phase represented by Li₃AlX2₆ can be identified from a diffraction pattern obtained by micro-X-ray diffraction (XRD) as described above or by powder XRD of a powder sample prepared by scraping the solid electrolyte. Furthermore, the composition of the solid electrolyte can be evaluated, for example, by elemental analysis using an electron probe micro analyzer (EPMA), energy dispersive X-ray spectroscopy (EDS), or the like.

The first halide solid electrolyte may include a crystalline phase represented by the following composition formula (3):

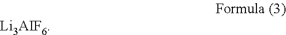

Accordingly, the first halide solid electrolyte has further enhanced atmospheric stability. Therefore, variations in the properties of the solid electrolyte caused by changes in environmental conditions during the manufacturing process can be suppressed, thereby reproducibly obtaining the solid electrolyte layer 300 having the desired properties. Furthermore, strict dew point environment control, temperature control, and humidity control are unnecessary, and therefore manufacturing advantages can also be obtained, such as a reduction in manufacturing cost.

The halide solid electrolyte may further include a second halide solid electrolyte having a composition different from the composition of the first halide solid electrolyte. According to this configuration, the binding property of the solid electrolyte in the solid electrolyte layer 300 can be further enhanced, achieving densification and enhanced ionic conductivity of the solid electrolyte layer 300.

The second halide solid electrolyte may have a lower melting point than the first halide solid electrolyte. Accordingly, in manufacturing the solid electrolyte layer 300 (e.g., during pressing for lamination), the second halide solid electrolyte, which has higher softness owing to its low melting point, tends to deform and fill the gaps between the first halide solid electrolytes. This facilitates densification of the solid electrolyte layer 300. In commonly used hot pressing, the second halide solid electrolyte having a low melting point exhibits particularly increased deformability. Densification enhances the ionic conductivity in the solid electrolyte layer 300, suppressing structural defects (e.g., voids or cracks). Fine voids and cracks, which serve as starting points where degradation of the properties becomes apparent due to external stress and thermal cycling, are reduced, and accordingly, the solid electrolyte layer 300 having high reliability can be obtained. Therefore, the battery 1000 having excellent performance and excellent reliability can be achieved.

The second halide solid electrolyte may be softer than the first halide solid electrolyte. Accordingly, in manufacturing the solid electrolyte layer (e.g., during pressing for lamination), the second halide solid electrolyte, which has higher softness, tends to deform and fill the gaps between the first halide solid electrolytes. This facilitates densification of the solid electrolyte layer 300. Densification enhances the ionic conductivity in the solid electrolyte layer 300, suppressing structural defects (e.g., voids or cracks). Fine voids and cracks, which serve as starting points where degradation of the properties becomes apparent due to external stress and thermal cycling, are reduced, and accordingly, the solid electrolyte layer 300 having high reliability can be obtained. Therefore, the battery 1000 having excellent performance and excellent reliability can be achieved. The comparison in softness between the second halide solid electrolyte and the first halide solid electrolyte can be evaluated, for example, by a method such as the micro Vickers method.

The second halide solid electrolyte may include a crystalline phase represented by the following composition formula (4):

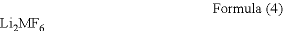

in the composition formula (4), M is at least one element selected from the group consisting of metal elements each having a valence of four and metalloid elements each having a valence of four.

The second halide solid electrolyte including the crystalline phase represented by the composition formula (4) is softer than the first halide solid electrolyte. This facilitates densification of the solid electrolyte layer 300 including the second halide solid electrolyte having such a configuration. This enhances the ionic conductivity in the solid electrolyte layer 300, suppressing structural defects (e.g., voids or cracks). Fine voids and cracks, which serve as starting points where degradation of the properties becomes apparent due to external stress and thermal cycling, are reduced, and accordingly, the solid electrolyte layer 300 having high reliability can be obtained. Therefore, the battery 1000 having excellent performance and excellent reliability can be achieved.

In the composition formula (4), M may include Ti, and M may be Ti. This increases the ionic conductivity of the second halide solid electrolyte to a level comparable to that of the first halide solid electrolyte (e.g., 1 μS/cm or more). Accordingly, the solid electrolyte layer 300 having high ionic conductivity and high reliability can be obtained. Therefore, the battery 1000 having excellent performance and excellent reliability can be obtained. Furthermore, when M is Ti, that is, when the second halide solid electrolyte has a composition of Li₂TiF₆, the second halide solid electrolyte can have stability and softness up to relatively high temperatures. Accordingly, the solid electrolyte layer 300 can also be densified, further enhancing the ionic conductivity of the solid electrolyte layer 300 (e.g., to 3 μS/cm or more). Therefore, the effects of incorporating the Al halide can be obtained up to relatively high temperatures.

The solid electrolyte layer 300, which includes the solid electrolyte, may include, for example, a binder, such as polyethylene oxide or polyvinylidene fluoride.

The solid electrolyte layer 300 may have a thickness of 5 μm or more and 500 μm or less, 10 μm or more and 500 μm or less, or 5 μm or more and 150 μm or less.

The material of the solid electrolyte may be composed of an aggregate of particles. Alternatively, the material of the solid electrolyte may be composed of a sintered structure.

### (Al Halide)

The Al halide included in the battery 1000 according to Embodiment 1 may be in particulate form, such as in the form of the Al halide particles 400. When the Al halide is in particulate form, the Al halide can be incorporated into the respective coating layers on the solid electrolyte particle and the active material particle or incorporated within the solid electrolyte particle. That is, the range of options for the form of the Al halide to be incorporated into the electrode layer and the solid electrolyte layer is broadened. Furthermore, for example, by using finely pulverized particles (e.g., particles having a particle diameter of 1 μm or less) of the Al halide material, it is possible to make the solid electrolyte layer 300 thinner or make the coating layers on the active material particles and the like thinner, thereby enhancing the capacity of the battery.

The Al halide particles 400 are, for example, uniformly dispersed within the first electrode layer 100 and within the solid electrolyte layer 300.

The Al halide particles 400 may have an average particle diameter of, for example, 0.3 μm or more and 20 μm or less. In FIG. 1, the Al halide particles 400 are shown as having a spherical particle shape; however, the particles may have a non-spherical particle shape, such as a flake shape.

A smaller particle diameter of the Al halide particles 400 is desirable. Accordingly, the Al halide particles 400 can be uniformly dispersed throughout the first electrode layer 100 and throughout the solid electrolyte layer 300, thereby increasing the surface area of the Al halide particle 400. Consequently, the bonding area between the Al halide particle 400 and the active material or the solid electrolyte, each of which is present around the Al halide particle 400, can be increased. Therefore, the mechanical reliability (flexural resistance) of the first electrode layer 100 and the solid electrolyte layer 300 is further enhanced by reducing the particle diameter of the Al halide particles 400 (e.g., reducing the particle diameter to 1 μm or less).

The Al halide includes, for example, AlF₃. The Al halide may be AlF₃. Owing to the inclusion of AlF₃ in the Al halide, for example, the mechanical bonding property (i.e., the anchoring effect) between the solid electrolyte particles and between the active material particles is enhanced by interposition of hard particles of AlF₃. For example, when AlF₃, which is harder than the solid electrolyte, is contained within the solid electrolyte particle, the solid electrolyte particle can be made harder. Furthermore, for example, when AlF₃ is included in the coating layer on the solid electrolyte particle and/or the active material particle, the AlF₃ also serves as an anchor that strengthens the bonding between particles. Therefore, a battery having excellent flexural resistance and excellent impact resistance can be obtained. AlF₃ has excellent heat resistance (e.g., about 1000° C.). Therefore, owing to the inclusion of AlF₃, excellent reliability of the battery 1000 can be obtained even at high temperatures.

The AlF₃ may have an orthorhombic and/or trigonal crystal structure. A desired crystal system can be obtained by adjusting the heat treatment conditions.

The AlF₃ having an orthorhombic crystal structure has excellent heat resistance, being stable even at high temperatures of, for example, about 400° C. The AlF₃ having an orthorhombic crystal structure can have heat resistance in a temperature range of, for example, 400° C. or higher and 1000° C. or lower. Furthermore, the AlF₃ having an orthorhombic crystal structure is hard, and accordingly, also contributes to enhancing the mechanical strength of the battery 1000. Accordingly, by incorporating the AlF₃ having an orthorhombic crystal structure into the electrode layer and/or the solid electrolyte layer 300, both the heat resistance and mechanical strength of the battery 1000 can be enhanced. In general, an organic binder incorporated into an all-solid-state battery rapidly softens at temperatures equal to or higher than its glass transition point, which is, for example, 100° C. or higher and 250° C. or lower. Accordingly, by incorporating the AlF₃ having an orthorhombic crystal structure into the electrode layer and/or the solid electrolyte layer 300, a decrease in the mechanical strength of the battery 1000 at high temperatures, for example, exceeding 100° C. can be suppressed.

When the AlF₃ having an orthorhombic crystal structure is in particulate form, at least a portion of the surface of the particle of the AlF₃ may be coated with a coating layer including a solid electrolyte. According to this configuration, the solid electrolyte coating the particle of the AlF₃ acts as a binder. Accordingly, the bonding property between the particles of the AlF₃ or between the particle of the AlF₃ and another type of particle (e.g., the solid electrolyte particle or the active material particle) is enhanced, further enhancing the reliability of the battery. For example, owing to the inclusion of the particles of the AlF₃ having such a configuration in the solid electrolyte layer, the ionic conductivity of the solid electrolyte layer is also enhanced.

AlF₃ having a trigonal crystal structure is softer than AlF₃ having an orthorhombic crystal structure, and is, for example, softer than the solid electrolyte. Accordingly, by incorporating AlF₃ having a trigonal crystal structure into the electrode layer and/or the solid electrolyte layer 300, the binding properties of the solid electrolyte particles and the active material particles at high temperatures can be enhanced.

AlF₃ having a combination of an orthorhombic crystal structure and a trigonal crystal structure may be incorporated into the electrode layer and/or the solid electrolyte layer 300. Accordingly, mechanical strength, heat resistance, and binding property can be adjusted by controlling the ratio between the crystal systems.

The AlF₃ incorporated into the electrode layer and/or the solid electrolyte layer 300 may include a first crystalline phase having an orthorhombic crystal structure and a second crystalline phase having a trigonal crystal structure. With such a configuration, AlF₃ can be achieved that has heat resistance at relatively high temperatures of, for example, about 200° C. to about 400° C., and that is, at the same time, softer than single-crystal AlF₃ having an orthorhombic crystal structure. Accordingly, by incorporating such AlF₃ into the battery 1000, the binding properties of the solid electrolyte particles and the active material particles at high temperatures can be enhanced. This enables the AlF₃ to absorb thermal expansion and contraction of, and heat generation by, the active material resulting from thermal cycling and charge and discharge cycling.

The crystal system of the AlF₃ can be identified, for example, from diffraction patterns obtained by micro-X-ray diffraction (micro-XRD) of respective side surfaces of the electrode layer and the solid electrolyte layer 300 that are exposed on a side surface of the battery 1000. Alternatively, the crystal system can be confirmed from a lattice image obtained using a high-resolution transmission electron microscope (TEM).

The AlF₃ may be in particulate form, in a surface region of the particle of the AlF₃, the content of the first crystalline phase may be greater than the content of the second crystalline phase, and in an inner region of the particle of the AlF₃, the content of the second crystalline phase may be greater than the content of the first crystalline phase. Thus, composite particles each including an orthorhombic crystal structure and a trigonal crystal structure in a single particle can also be used. According to this configuration, the particle of the AlF₃ can exhibit, even at high temperatures, an anchoring effect resulting from the hard surface layer, and can also exhibit deformability resulting from an inner portion of the particle that is softer than the surface layer. This facilitates densification of the solid electrolyte layer and/or the electrode layer, each of which includes the particles of the AlF₃, and also enhances the bonding property between the solid electrolyte particles and between the active material particles. Therefore, a battery having further enhanced reliability can be obtained.

The morphology of composite particles as described above can be evaluated, for example, by SEM observation of an ion-polished cross section of the battery.

When the AlF₃ is in the form of composite particles as described above, that is, when the AlF₃ including an orthorhombic crystal structure and a trigonal crystal structure is in particulate form, at least a portion of the surface of the particle of the AlF₃ may be coated with a coating layer including a solid electrolyte. This enhances the bonding property between the AlF₃ and the solid electrolyte included in the electrolyte layer or in the electrode layer. Therefore, reliability against thermal shock and external stress applied to the solid electrolyte layer and the electrode layer is enhanced.

When the Al halide includes AlF₃ in particulate form, the particles of the AlF₃ may include: a first particle formed of AlF₃ having an orthorhombic crystal structure; and a second particle including the first crystalline phase having an orthorhombic crystal structure and the second crystalline phase having a trigonal crystal structure. Accordingly, the heat resistance, mechanical strength, deformability, and densification property of the AlF₃ can be adjusted depending on the intended application by controlling the mixing ratio between the first particles and the second particles.

The average particle diameter of the second particles may be larger than the average particle diameter of the first particles. Accordingly, the second crystalline phase having excellent deformability can reduce voids (gaps between particles) that tend to form around the larger second particles, densifying the electrolyte layer and the electrode layer. This enhances the electrical characteristics and reliability of the battery 1000.

The content of the Al halide in the solid electrolyte layer 300 may be, for example, 0.01 vol % or more and 5 vol % or less. The content of the Al halide in the first electrode layer 100 may be, for example, 0.01 vol % or more and 3 vol % or less. The content of the Al halide, as described above, can be confirmed by elemental analysis using a high-resolution compositional map obtained using, for example, EPMA of a cross section processed by ion polishing or the like.

The Al halide may be dispersed in the solid electrolyte layer 300 and/or the electrode layer so as to be present between the solid electrolyte particles and/or between the active material particles or in gap portions, and may be included in the solid electrolyte layer 300 and/or the electrode layer in another form.

For example, the Al halide may be included in a coating layer coating at least a portion of the surface of the solid electrolyte particle and/or the active material particle. This enhances the mechanical bonding property (i.e., anchoring effect) between the solid electrolyte particles and/or between the active material particles, enhancing the reliability of the battery 1000 against external stress, thermal cycling, and the like applied to the solid electrolyte layer 300 and/or the electrode layer.

When at least one selected from the group consisting of the first electrode layer 100 and the second electrode layer 200 includes an active material particle and a coating layer coating at least a portion of the surface of the active material particle, this coating layer may include the Al halide. According to this configuration, the binding property and mechanical bonding property (i.e., the anchoring effect) between the active material particles can be enhanced. This enhances the strength of the electrode layer against external stress, thermal cycling, and the like, and thus the occurrence of structural defects such as cracking in the electrode layer can be suppressed. Therefore, the reliability of the battery 1000 can be further enhanced.

When at least one selected from the group consisting of the first electrode layer 100, the second electrode layer 200, and the solid electrolyte layer 300 includes a solid electrolyte particle and a coating layer coating at least a portion of the surface of the solid electrolyte particle, this coating layer may include the Al halide. According to this configuration, the binding property and mechanical bonding property (i.e., the anchoring effect) between the solid electrolyte particles included in the electrode layer and/or the solid electrolyte layer 300, each of which is a power-generating element of the battery 1000, can be enhanced. This enhances the strength of the power-generating element against external stress, thermal cycling, and the like, and therefore the reliability of the battery 1000 can be further enhanced.

At least one selected from the group consisting of the first electrode layer 100, the second electrode layer 200, and the solid electrolyte layer 300 may include a solid electrolyte particle, and the Al halide may be contained within this solid electrolyte particle. For example, the Al halide may be encapsulated within the solid electrolyte particle. In other words, at least a portion of the surface of the particle of the Al halide may be coated with a coating layer including a solid electrolyte. According to this configuration, the hardness of the solid electrolyte particles included in the electrode layer and/or the solid electrolyte layer 300, each of which is a power-generating element of the battery, can be adjusted depending on the purpose, for example, by making the solid electrolyte particles softer to enhance deformability or harder to enhance strength. This enhances the reliability of the power-generating element against external stress, thermal cycling, and the like, and therefore the reliability of the battery 1000 can be further enhanced. The hardness of the solid electrolyte particles can be adjusted by selecting a halogen element in the Al halide material or by incorporating a combination of a plurality of halogen elements. Furthermore, because the Al halide material is contained within the solid electrolyte particle, a reduction in ionic conductivity between the solid electrolyte particles caused by the Al halide material is suppressed.

The solid electrolyte particle encapsulating the Al halide can be produced, for example, by using, as starting materials for synthesizing the solid electrolyte particles, the Al halide or a raw material including a substance that generates the Al halide as an intermediate, and controlling the synthesis conditions of the solid electrolyte (e.g., heat treatment conditions or conditions of mechanical energy imparted during mechanochemical treatment). That is, the solid electrolyte particle encapsulating the Al halide can be produced by using synthesis conditions under which the Al halide is present within the particle and the synthesized solid electrolyte is present on the particle surface. For example, during heat treatment in the synthesis of the solid electrolyte, setting the heat treatment temperature lower than usual and/or setting the heat treatment time shorter than usual facilitates the production of the solid electrolyte particle encapsulating the Al halide. Furthermore, during mixing and/or dispersion of the starting materials, setting the mixing time shorter than usual and/or setting the dispersion time shorter than usual also facilitates the production of the solid electrolyte particle encapsulating the Al halide. In addition to these methods, it is also possible to produce the solid electrolyte particle encapsulating the Al halide by coating the surface of the Al halide particle with a coating of the solid electrolyte.

The Al halide may be incorporated at the bonding interface between the solid electrolyte layer 300 and the electrode layer. This configuration enhances the bonding property between the solid electrolyte layer 300 and the electrode layer, thereby suppressing delamination that tends to occur due to external impact and thermal cycling.

The inclusion of the Al halide in the battery 1000 can be determined using EPMA, EDS, or X-ray fluorescence analysis (XRF). Furthermore, its morphology and composition can be analyzed by compositional analysis (point analysis or area analysis) using EPMA, EDS, or the like on a polished cross section processed with an ion polisher or the like.

By incorporating, as the Al halide having a low melting point and being soft, at least one selected from the group consisting of AlCl₃, AlBr₃, and AlI₃, the solid electrolyte layer 300 and/or the electrode layer can be densified, reducing resistance and thus achieving a reduction in resistance loss.

In this manner, by incorporating the Al halide into the solid electrolyte layer 300 and/or the electrode layer, in both of which structural defects tend to occur due to external impact, charge and discharge cycling, and thermal cycling, it is possible to suppress structural defects and deterioration of material properties. Therefore, degradation of the properties of the solid electrolyte layer 300 and/or the electrode layer can be reduced, and the battery 1000 having high reliability can be achieved.

The softness of the Al halide may be adjusted depending on the purpose. For example, a plurality of Al halides may be used in combination. This enhances the mechanical strength of the battery 1000, enabling suppression of the occurrence of structural defects resulting from external impact, charge and discharge cycling, and thermal cycling.

### Embodiment 2

A battery of Embodiment 2 is described below. The matters described in Embodiment 1 may be omitted as appropriate.

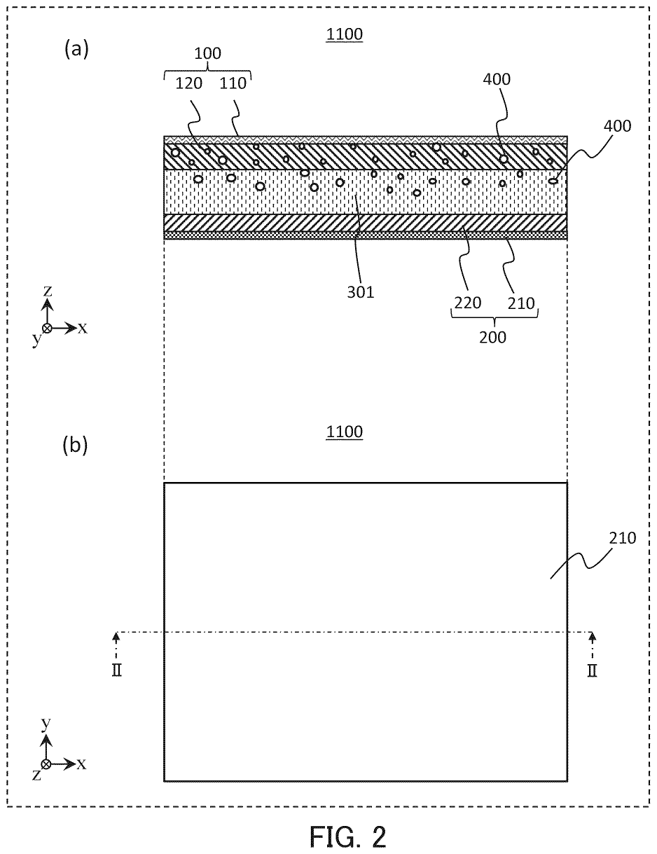

FIG. 2 is a cross-sectional view and a plan view schematically showing the configuration of a battery 1100 according to Embodiment 2.

FIG. 2(a) is a cross-sectional view of the battery 1100 according to Embodiment 2. FIG. 2(b) is a plan view of the battery 1100 according to Embodiment 2 as viewed from below in the z-axis direction. In FIG. 2(a), a cross section at the position indicated by dotted line II-II in FIG. 2(b) is shown.

As shown in FIG. 2, the battery 1100 according to Embodiment 2 is different from the battery 1000 according to Embodiment 1 in the configuration of the solid electrolyte layer.

A solid electrolyte layer 301 in the battery 1100 according to Embodiment 2 differs in that, in the solid electrolyte layer 301, the Al halide particles 400, which are included as the Al halide, are present in a concentrated manner in a region on the side in contact with the first active material layer 120, and are absent in a region on the side in contact with the second active material layer 220. According to such a configuration, the Al halide can be selectively incorporated into a region on the side of the electrode layer that is susceptible to the occurrence of structural defects, for example, the electrode layer including an active material that undergoes significant expansion and contraction during charging and discharging or has a high thermal expansion coefficient. Therefore, the reliability of the battery 1100 can be efficiently enhanced.

An example of a modification of the battery 1100 according to Embodiment 2 is a configuration in which the concentration of the Al halide particles 400 in the region of the solid electrolyte layer 301 on the side in contact with the first active material layer 120 is higher than the concentration of the Al halide particles 400 in the region of the solid electrolyte layer 301 on the side in contact with the second active material layer 220. Even with such a configuration, the reliability of the battery 1100 can be efficiently enhanced.

### Embodiment 3

A battery of Embodiment 3 is described below. The matters described in the above embodiments may be omitted as appropriate.

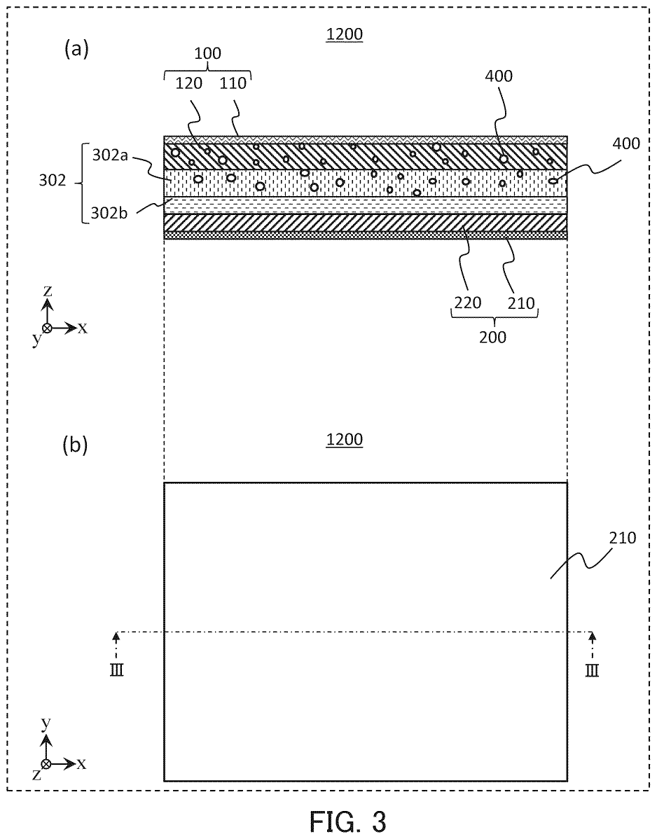

FIG. 3 is a cross-sectional view and a plan view schematically showing the configuration of a battery 1200 according to Embodiment 3.

FIG. 3(a) is a cross-sectional view of the battery 1200 according to Embodiment 3. FIG. 3(b) is a plan view of the battery 1200 according to Embodiment 3 as viewed from below in the z-axis direction. In FIG. 3(a), a cross section at the position indicated by line III-III in FIG. 3(b) is shown.

As shown in FIG. 3, the battery 1200 according to Embodiment 3 differs from the battery 1000 according to Embodiment 1 in the configuration of the solid electrolyte layer.

A solid electrolyte layer 302 in the battery 1200 according to Embodiment 3 includes a first layer 302a in contact with the first electrode layer 100 and a second layer 302b in contact with the second electrode layer 200. The first layer 302a and the second layer 302b include respective solid electrolytes each having a different composition. The first layer 302a includes the Al halide particles 400 as the Al halide. The second layer 302b does not include the Al halide. For example, from the perspective of electrochemical stability and the like, the solid electrolyte material in contact with the first electrode layer 100 and the solid electrolyte material in contact with the second electrode layer 200 may each be formed of a different material. In one example, a configuration may be employed in which a halide solid electrolyte is used as the solid electrolyte material on the positive electrode layer side, and a sulfide solid electrolyte is used as the solid electrolyte material on the negative electrode layer side. When the solid electrolyte layer is composed of a plurality of layers each formed of a different material, as described above, selective incorporation of the Al halide into a layer formed of a material that is susceptible to the occurrence of structural defects enables selective suppression of such defects. Therefore, the reliability of the battery 1200 can be efficiently enhanced.

An example of a modification of the battery 1200 according to Embodiment 3 is a configuration in which both the first layer 302a and the second layer 302b include the Al halide particles 400, and the concentration of the Al halide particles 400 in the first layer 302a is higher than the concentration of the Al halide particles 400 in the second layer 302b. Even with such a configuration, the reliability of the battery 1200 can be efficiently enhanced.

### Embodiment 4

A battery of Embodiment 4 is described below. The matters described in the above embodiments may be omitted as appropriate.

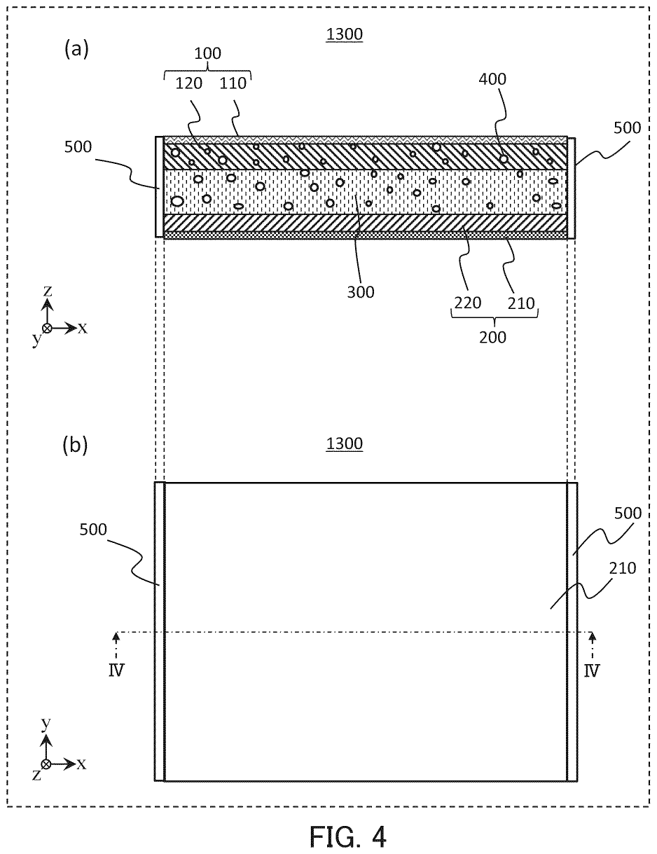

FIG. 4 is a cross-sectional view and a plan view schematically showing the configuration of a battery 1300 according to Embodiment 4.

FIG. 4(a) is a cross-sectional view of the battery 1300 according to Embodiment 4. FIG. 4(b) is a plan view of the battery 1300 according to Embodiment 4 as viewed from below in the z-axis direction. In FIG. 4(a), a cross section at the position indicated by line IV-IV in FIG. 4(b) is shown.

As shown in FIG. 4, the battery 1300 according to Embodiment 4 differs from the battery 1000 according to Embodiment 1 in that the battery 1300 further includes a side surface layer 500, the side surface layer 500 is disposed on a side surface of at least one layer selected from the group consisting of the first electrode layer 100, the second electrode layer 200, and the electrolyte layer 300, and the side surface layer 500 includes the Al halide. That is, the battery 1300 according to Embodiment 4 satisfies the above configuration (II).

According to such a configuration, the battery 1300 according to Embodiment 4 can achieve suppression of external stress applied from the side surface and suppression of the occurrence of structural defects in the side surface portion. Consequently, even higher reliability of the battery 1300 can be achieved.

In the battery 1300 according to Embodiment 4, the side surface layer 500 includes the Al halide. The description of the Al halide included in the side surface layer 500 is the same as the description of the Al halide in Embodiment 1, and accordingly, a detailed description thereof is omitted here.

The side surface layer 500 may include, for example, Al halide particles and an organic binder for binding. The side surface layer 500 can be formed, for example, by applying a paste including the Al halide particles and the organic binder onto a side surface of at least one layer selected from the group consisting of the first electrode layer 100, the second electrode layer 200, and the electrolyte layer 300, and drying the coating film.

The side surface layer 500 may have a thickness of, for example, 1 μm or more and 30 μm or less.

While satisfying the configuration (II), the battery 1300 according to Embodiment 4 also satisfies a configuration in which the Al halide is included in a power-generating element, that is, the above configuration (I); however, the battery 1300 may not satisfy the above configuration (I). That is, the Al halide may be included in none of the power-generating elements.

### Embodiment 5

A battery of Embodiment 5 is described below. The matters described in the above embodiments may be omitted as appropriate.

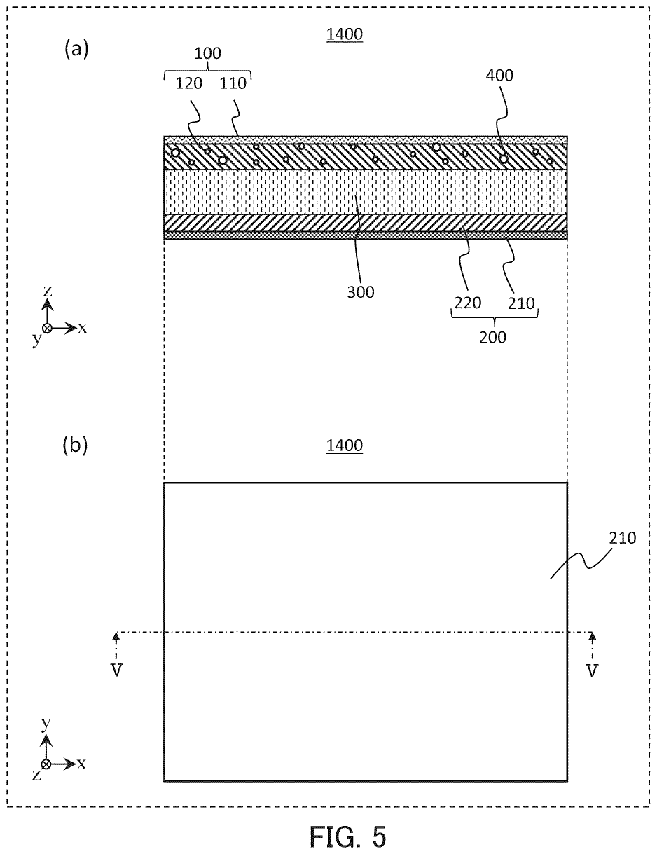

FIG. 5 is a cross-sectional view and a plan view schematically showing the configuration of a battery 1400 according to Embodiment 5.

FIG. 5(a) is a cross-sectional view of the battery 1400 according to Embodiment 5. FIG. 5(b) is a plan view of the battery 1400 according to Embodiment 5 as viewed from below in the z-axis direction. In FIG. 5(a), a cross section at the position indicated by line V-V in FIG. 5(b) is shown.

As shown in FIG. 5, the battery 1400 according to Embodiment 5 differs from the battery 1000 according to Embodiment 1 in that the Al halide particles 400 as the Al halide are included only in the first electrode layer 100.

According to such a configuration, for example, it is possible to suppress an issue in which structural defects tend to occur in a layer (e.g., the electrode layer) that undergoes significant thermal expansion and contraction during charge and discharge cycling and thermal cycling. Consequently, higher reliability of the battery 1400 can be achieved.

### Embodiment 6

A battery of Embodiment 6 is described below. The matters described in the above embodiments may be omitted as appropriate.

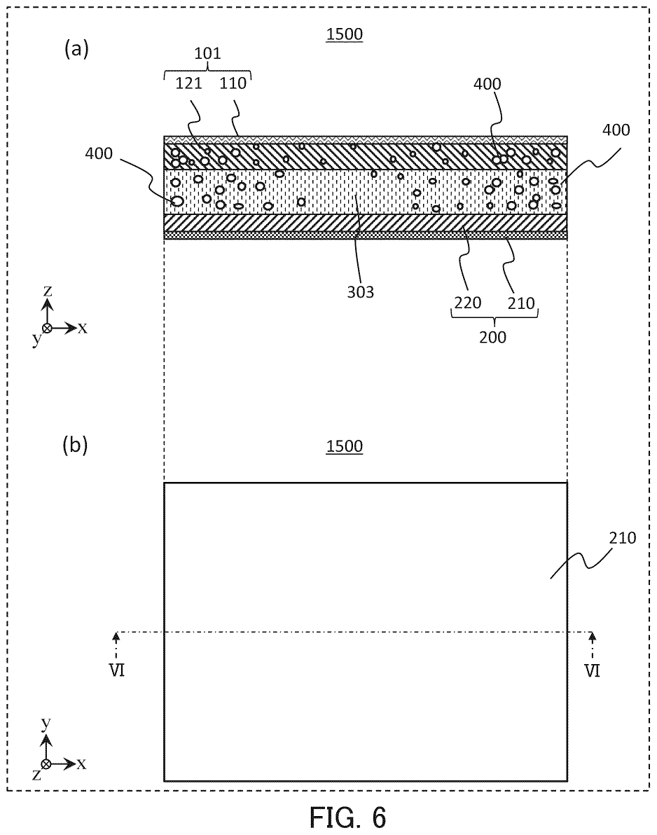

FIG. 6 is a cross-sectional view and a plan view schematically showing the configuration of a battery 1500 according to Embodiment 6.

FIG. 6(a) is a cross-sectional view of the battery 1500 according to Embodiment 6. FIG. 6(b) is a plan view of the battery 1500 according to Embodiment 6 as viewed from below in the z-axis direction. In FIG. 6(a), a cross section at the position indicated by line VI-VI in FIG. 6(b) is shown.

As shown in FIG. 6, the battery 1500 according to Embodiment 6 differs from the battery 1000 according to Embodiment 1 in that the concentration of the Al halide included in the first electrode layer and in the solid electrolyte layer varies within each layer.

In a first electrode layer 101 and a solid electrolyte layer 303, the concentration of the Al halide particles 400 is higher on the outer periphery side (the side closer to the side surface). In the battery 1500 shown in FIG. 6, the concentration of the Al halide particles 400 gradually and continuously varies toward the outer periphery side; however, the configuration may be such that the concentration varies stepwise.

According to such a configuration, the battery 1500 can be such that, in each of the first electrode layer 101 (e.g., a first active material layer 121) and the solid electrolyte layer 303, which are susceptible to damage from external impact (or susceptible to delamination (between or within layers) resulting from charging and discharging and thermal cycling), the outer periphery side is surrounded by a region having an increased concentration of the Al halide particles 400. Accordingly, structural defects in a region on the outer periphery side of a power-generating element, which is susceptible to the occurrence of structural defects, can be effectively suppressed. In plan view, a region having a higher concentration of the Al halide particles 400 may have, for example, a circular or polygonal shape in addition to a rectangular shape, and high reliability can be achieved by shaping the region so as to surround an outer peripheral portion and thus to protect the interior of the battery.

In Embodiments 1 to 6, the battery of the present disclosure has been described taking an all-solid-state battery as an example. However, the battery of the present disclosure is not limited to an all-solid-state battery and may be a liquid battery. That is, in the battery of the present disclosure, the electrolyte layer may be composed, for example, of an electrolyte solution and a separator impregnated with the electrolyte solution. Even in the case of a liquid battery, a battery having high reliability can be achieved by including the Al halide in a manner similar to that in the all-solid-state batteries described in Embodiments 1 to 6.

In the case of a liquid battery, at least one selected from the group consisting of the first electrode layer and the second electrode layer includes the Al halide. In this case, the Al halide is included, for example, in a coating layer coating at least a portion of the surface of the active material particle. This coating layer may include, for example, a solid electrolyte and the Al halide.

### Method for Manufacturing Battery

Next, an example of a method for manufacturing the battery according to the present embodiment is described. The following describes a method for manufacturing the battery 1000 according to Embodiment 1 described above.

The following describes an example in which the first electrode layer 100 is the positive electrode layer and the second electrode layer 200 is the negative electrode layer. That is, in the following description, the first active material layer 120 is the positive electrode active material layer, the first current collector 110 is the positive electrode current collector, the second active material layer 220 is the negative electrode active material layer, and the second current collector 210 is the negative electrode current collector.

First, pastes to be used for forming the positive electrode active material layer and the negative electrode active material layer by printing are prepared. The solid electrolyte prepared for use in respective mixtures for the positive electrode active material layer and the negative electrode active material layer is, for example, a solid electrolyte powder (Li₃AlF₆—Li₂TiF₆) having an average particle diameter of about 3 μm and including a halide as its main component. As this powder, for example, a powder having high ionic conductivity (e.g., 1×10⁻³ S/cm to 3×10⁻³ S/cm) is used.

As the positive electrode active material, for example, a Li·Ni·Co·Al composite oxide powder (LiNi_{0.8}Co_{0.15}Al_{0.05}O₂) having an average particle diameter of about 5 μm and a layered structure is used. Furthermore, as the Al halide material, an Al fluoride powder having an average particle diameter of about 1 μm is prepared.

A positive electrode active material layer paste, in which a mixture obtained by incorporating the above positive electrode active material, the above solid electrolyte powder, and the Al fluoride (AlF₃) powder is dispersed in an organic solvent or the like, is prepared using a three-roll mill.

As the negative electrode active material, for example, a natural graphite powder having an average particle diameter of about 10 μm is used. A negative electrode active material layer paste, in which a mixture obtained by incorporating the above negative electrode active material and the above solid electrolyte powder is dispersed in an organic solvent or the like, is prepared in the same manner as the positive electrode active material layer paste.

Subsequently, as a material for use in the positive electrode current collector and the negative electrode current collector, for example, a copper foil having a thickness of about 30 μm is prepared. The positive electrode active material layer paste and the negative electrode active material layer paste are each printed on one surface of the corresponding copper foil by a screen printing method to have a predetermined shape and a thickness of about 50 μm to about 100 μm. The positive electrode active material layer paste and the negative electrode active material layer paste are dried at 80° C. to 130° C. to have a thickness of 30 μm to 60 μm. The positive electrode active material layer paste includes the AlF₃ powder. Thus, respective current collectors (copper foils) are obtained on which the positive electrode active material layer and the negative electrode active material layer are formed.

Subsequently, a solid electrolyte layer paste dispersed in an organic solvent or the like is prepared with the incorporation of the Al fluoride (AlF₃) powder. On the principal surface of the positive electrode active material layer formed on the positive electrode current collector, the above solid electrolyte layer paste including the AlF₃ powder is printed using a metal mask to have a thickness of, for example, about 100 μm. On the principal surface of the negative electrode active material layer formed on the negative electrode current collector, the above solid electrolyte layer paste including the AlF₃ powder is printed using a metal mask to have a thickness of, for example, about 100 μm. Thereafter, the positive electrode active material layer and the negative electrode active material layer, on which the solid electrolyte layer pastes are printed on their principal surfaces, are dried at 80° C. to 130° C.

Subsequently, these electrode structures are stacked so that the solid electrolyte printed on the positive electrode active material layer formed on the positive electrode current collector and the solid electrolyte printed on the negative electrode active material layer formed on the negative electrode current collector are in contact with and face each other. The resulting stack is placed in a die having a rectangular outer shape.

Subsequently, an elastic sheet having, for example, a thickness of about 50 μm to about 100 μm and an elastic modulus of about 5×10⁶ Pa is inserted between a press die and the above stack. According to this configuration, a pressure is applied to the stack through the elastic sheet. Thereafter, the stack is pressed, for example, for 90 seconds while the press die is heated to 50° C. to 80° C. under a pressure of 300 MPa to 350 MPa. Thus, a battery including a positive electrode layer, a negative electrode layer, and an electrolyte layer disposed between the positive electrode layer and the negative electrode layer is obtained.

The battery manufacturing method is not limited to the above example.

In the above manufacturing method, an example is presented in which the positive electrode active material layer paste, the negative electrode active material layer paste, and the solid electrolyte layer paste are applied by printing; however, printing is not limited to this. The printing method may be, for example, a doctor blade method, a calendering method, a spin coating method, a dip coating method, an inkjet method, an offset method, a die coating method, or a spray method.

### Other Embodiments

### (Supplementary Description)

The above description of the embodiments discloses the following techniques.

### (Technique 1)

A battery including:
a first electrode layer;
a second electrode layer; and
an electrolyte layer disposed between the first electrode layer and the second electrode layer, wherein
the battery satisfies at least one configuration selected from the group consisting of the following (I) and (II):
(I) at least one selected from the group consisting of the first electrode layer, the second electrode layer, and the electrolyte layer includes an Al halide; and
(II) the battery further includes a side surface layer, the side surface layer being disposed on a side surface of at least one layer selected from the group consisting of the first electrode layer, the second electrode layer, and the electrolyte layer, the side surface layer including an Al halide, and
the Al halide is represented by the following composition formula (1):

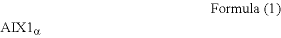

in the composition formula (1), the X1 is at least one selected from the group consisting of F, Cl, Br, and I, and the α satisfies 2.95≤α≤3.05.

The Al halide in which X1 is, for example, Cl, Br, or I has a relatively low melting point and is soft, and accordingly can act effectively as a binder and a stress-absorbing material. Furthermore, the Al halide in which X1 is, for example, F has a relatively high melting point and is hard, and accordingly can act effectively as a reinforcing material. These actions of the Al halide can be adjusted by selecting the halogen element X1 in the Al halide. Accordingly, a plurality of halogen elements may be incorporated depending on the desired properties so that an enhancement in mechanical strength by stress absorption and an enhancement in mechanical strength by reinforcement can be effectively combined, and a halogen element may be selected for the purpose of either enhancing mechanical strength by stress absorption or enhancing mechanical strength by reinforcement. Accordingly, by including the Al halide, the battery according to Technique 1 can have effectively enhanced strength against stress caused by external impact, thermal shock, and expansion and contraction of the battery resulting from charging and discharging or heating and cooling. Therefore, the battery according to Technique 1 can have enhanced mechanical strength and thus enhanced reliability.

The above effects can be achieved by any of the above configurations (I) and (II). For example, when the above configuration (I) is satisfied, it is possible to enhance the strength of the electrode layer and/or the electrolyte layer, each of which is a power-generating element of the battery. This enhances the reliability of the battery. Furthermore, when the above configuration (II) is satisfied, it is possible to effectively suppress, by the side surface layer including the Al halide, structural defects that tend to occur at a side surface of the battery serving as an initiation site (i.e., cracking or peeling originating from a side surface) and in which the influence of external impact and thermal shock tends to become apparent. This enhances the reliability of the battery.

### (Technique 2)

The battery according to Technique 1, wherein
the electrolyte layer is a solid electrolyte layer.

According to this configuration, an all-solid-state battery having enhanced reliability can be provided.

### (Technique 3)

The battery according to Technique 2, wherein
the solid electrolyte layer includes a halide solid electrolyte.

According to this configuration, the halide solid electrolyte included in the solid electrolyte layer and the Al halide have thermal expansion characteristics that tend to match each other because both are halides. Accordingly, the bonding interface between the Al halide and the halide solid electrolyte becomes firm. This suppresses the occurrence of structural defects caused by peeling at the bonding interface between the Al halide and the halide solid electrolyte that results from thermal shock or thermal cycling. That is, according to the above configuration, the effectiveness of the Al halide against thermal shock and thermal cycling is further enhanced. Therefore, a battery having higher reliability can be obtained.

### (Technique 4)

The battery according to Technique 1, wherein
the electrolyte layer is composed of an electrolyte solution and a separator impregnated with the electrolyte solution.

According to this configuration, a liquid battery having enhanced reliability can be provided.

### (Technique 5)

The battery according to any one of Techniques 1 to 4, wherein
the battery satisfies the (I),
at least one selected from the group consisting of the first electrode layer, the second electrode layer, and the electrolyte layer includes a solid electrolyte particle and a coating layer coating at least a portion of a surface of the solid electrolyte particle, and
the coating layer includes the Al halide.

According to this configuration, the binding property and mechanical bonding property (i.e., the anchoring effect) between the solid electrolyte particles included in the electrode layer and/or the electrolyte layer, each of which is a power-generating element of the battery, can be enhanced. This enhances the strength of the power-generating element against external stress, thermal cycling, and the like, and therefore the reliability of the battery can be further enhanced.

### (Technique 6)

The battery according to any one of Techniques 1 to 4, wherein
the battery satisfies the (I),
at least one selected from the group consisting of the first electrode layer, the second electrode layer, and the electrolyte layer includes a solid electrolyte particle, and
the Al halide is contained within the solid electrolyte particle.

According to this configuration, the hardness of the solid electrolyte particles included in the electrode layer and/or the electrolyte layer, each of which is a power-generating element of the battery, can be adjusted depending on the purpose, for example, by making the solid electrolyte particles softer to enhance deformability or harder to enhance strength. This enhances the reliability of the power-generating element against external stress, thermal cycling, and the like, and therefore the reliability of the battery can be further enhanced. The hardness of the solid electrolyte particles can be adjusted by selecting a halogen element in the Al halide material or by incorporating a combination of a plurality of halogen elements. Furthermore, because the Al halide material is contained within the solid electrolyte particle, a reduction in ionic conductivity between the solid electrolyte particles caused by the Al halide material is suppressed.

### (Technique 7)

The battery according to any one of Techniques 1 to 6, wherein
the battery satisfies the (I),
at least one selected from the group consisting of the first electrode layer and the second electrode layer includes an active material particle and a coating layer coating at least a portion of a surface of the active material particle, and
the coating layer includes the Al halide.

According to this configuration, the binding property and mechanical bonding property (i.e., the anchoring effect) between the active material particles can be enhanced. This enhances the strength of the electrode layer against external stress, thermal cycling, and the like, and thus the occurrence of structural defects such as cracking in the electrode layer can be suppressed. Therefore, the reliability of the battery can be further enhanced.

### (Technique 8)

The battery according to any one of Techniques 1 to 7, wherein
the Al halide is in particulate form.

This configuration facilitates incorporation of the Al halide into the respective coating layers on the solid electrolyte particle and the active material particle, or incorporation of the Al halide within the solid electrolyte particle. Furthermore, for example, by using finely pulverized particles (e.g., particles having a particle diameter of 1 μm or less) of the Al halide material, it is possible to make the electrolyte layer thinner or make the coating layers on the active material particles and the like thinner, thereby enhancing the capacity of the battery.

### (Technique 9)

The battery according to any one of Techniques 1 to 8, wherein
the Al halide includes AlF₃.

According to this configuration, for example, the mechanical bonding property (i.e., the anchoring effect) between the solid electrolyte particles and between the active material particles is enhanced by interposition of hard particles of AlF₃. For example, when AlF₃, which is harder than the solid electrolyte, is contained within the solid electrolyte particle, the solid electrolyte particle can be made harder. Furthermore, for example, when AlF₃ is included in the coating layer on the solid electrolyte particle and/or the active material particle, the AlF₃ also serves as an anchor that strengthens the bonding between particles. Therefore, a battery having excellent flexural resistance and excellent impact resistance can be obtained. AlF₃ has excellent heat resistance (e.g., about 1000° C.). Therefore, excellent reliability can be obtained even at high temperatures.

### (Technique 10)

The battery according to Technique 9, wherein
the AlF₃ has an orthorhombic crystal structure.

Accordingly, it is possible to obtain highly heat-resistant AlF₃ that is stable even at high temperatures of, for example, about 400° C. Accordingly, AlF₃ having excellent mechanical strength and excellent heat resistance can be incorporated into the battery, and therefore a battery having further excellent reliability can be obtained. The crystal system of the AlF₃ can be identified, for example, from a diffraction pattern obtained by micro-XRD of a surface exposed on a side surface of the battery. Alternatively, the crystal system can be confirmed from a lattice image obtained using a high-resolution TEM.

### (Technique 11)

The battery according to Technique 10, wherein
the AlF₃ is in particulate form, and
at least a portion of a surface of a particle of the AlF₃ is coated with a coating layer including a solid electrolyte.

According to this configuration, the solid electrolyte coating the particle of the AlF₃ acts as a binder. Accordingly, the bonding property between the particles of the AlF₃ or between the particle of the AlF₃ and another type of particle (e.g., the solid electrolyte particle or the active material particle) is enhanced, further enhancing the reliability of the battery. For example, owing to the inclusion of the particles of the AlF₃ having such a configuration in the solid electrolyte layer, the ionic conductivity of the solid electrolyte layer is also enhanced.

### (Technique 12)

The battery according to Technique 9, wherein
the AlF₃ includes a first crystalline phase having an orthorhombic crystal structure and a second crystalline phase having a trigonal crystal structure.

Accordingly, AlF₃ can be obtained that has heat resistance at relatively high temperatures of, for example, about 200° C. to about 400° C., and that is, at the same time, softer than single-crystal AlF₃ having an orthorhombic crystal structure. Accordingly, by incorporating such AlF₃ into the battery, the binding properties of the solid electrolyte particles and the active material particles at high temperatures can be enhanced. This enables the AlF₃ to absorb thermal expansion and contraction of, and heat generation by, the active material resulting from thermal cycling and charge and discharge cycling.

### (Technique 13)

The battery according to Technique 12, wherein
the AlF₃ is in particulate form,
in a surface region of a particle of the AlF₃, a content of the first crystalline phase is greater than a content of the second crystalline phase, and
in an inner region of the particle of the AlF₃, the content of the second crystalline phase is greater than the content of the first crystalline phase.

According to this configuration, the particle of the AlF₃ can exhibit, even at high temperatures, an anchoring effect resulting from the hard surface layer, and can also exhibit deformability resulting from an inner portion of the particle that is softer than the surface layer. This facilitates densification of the solid electrolyte layer and/or the electrode layer, each of which includes the particles of the AlF₃, and also enhances the bonding property between the solid electrolyte particles and between the active material particles. Therefore, a battery having further enhanced reliability can be obtained.

### (Technique 14)

The battery according to Technique 12 or 13, wherein
the AlF₃ is in particulate form, and
at least a portion of a surface of a particle of the AlF₃ is coated with a coating layer including a solid electrolyte.

This enhances the bonding property between the AlF₃ and the solid electrolyte included in the electrolyte layer or in the electrode layer. Therefore, reliability against thermal shock and external stress applied to the solid electrolyte layer and the electrode layer is enhanced.

### (Technique 15)

The battery according to Technique 9, wherein
the Al halide includes AlF₃ in particulate form, and
particles of the AlF₃ include:
   a first particle formed of AlF₃ having an orthorhombic crystal structure; and
   a second particle including a first crystalline phase having an orthorhombic crystal structure and a second crystalline phase having a trigonal crystal structure.

Accordingly, the heat resistance, mechanical strength, deformability, and densification property of the AlF₃ can be adjusted depending on the intended application by controlling the mixing ratio between the first particles and the second particles.

### (Technique 16)

The battery according to Technique 15, wherein
an average particle diameter of the second particles is larger than an average particle diameter of the first particles.

Accordingly, the second crystalline phase having excellent deformability can reduce voids (gaps between particles) that tend to form around the larger second particles, densifying the electrolyte layer and the electrode layer. This enhances the electrical characteristics and reliability of the battery.

### (Technique 17)

The battery according to Technique 3, wherein
the halide solid electrolyte includes Al.

According to this configuration, a solid electrolyte layer including a solid electrolyte having a high ionic conductivity of, for example, 1 μS/cm or more, can be obtained. Furthermore, owing to the presence of Al, which is included in both the Al halide and the halide solid electrolyte in common, the Al halide and the solid electrolyte firmly bond to each other, facilitating formation of an integrated bonding interface. Accordingly, when the Al halide is included in the solid electrolyte layer, the Al halide can coexist with the solid electrolyte within the solid electrolyte layer, in a stable manner (e.g., with no formation of fine defects in the surrounding region). Therefore, a battery having further enhanced reliability can be obtained.

### (Technique 18)

The battery according to Technique 17, wherein
the halide solid electrolyte includes a first halide solid electrolyte including a crystalline phase represented by the following composition formula (2):

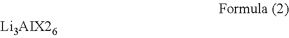

in the composition formula (2), the X2 is at least one selected from the group consisting of F, Cl, Br, and I.

According to this configuration, the solid electrolyte layer includes a solid electrolyte having a high ionic conductivity of, for example, 1 μS/cm or more, atmospheric stability, and heat resistance, thereby enhancing the ionic conductivity and reliability of the solid electrolyte layer. The crystalline phase represented by Li₃AlX2₆ can be identified from a diffraction pattern obtained by micro-XRD as described above or by powder XRD of a powder sample prepared by scraping the solid electrolyte. Furthermore, the composition of the solid electrolyte can be evaluated, for example, by elemental analysis using EPMA, EDS, or the like.

### (Technique 19)

The battery according to Technique 18, wherein
the first halide solid electrolyte includes a crystalline phase represented by the following composition formula (3):

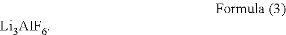

Accordingly, the first halide solid electrolyte has further enhanced atmospheric stability. Therefore, variations in the properties of the solid electrolyte caused by changes in environmental conditions during the manufacturing process can be suppressed, thereby reproducibly obtaining the solid electrolyte layer having the desired properties. Furthermore, strict dew point environment control, temperature control, and humidity control are unnecessary, and therefore manufacturing advantages can also be obtained, such as a reduction in manufacturing cost.

### (Technique 20)

The battery according to Technique 18 or 19, wherein
the halide solid electrolyte further includes a second halide solid electrolyte having a composition different from a composition of the first halide solid electrolyte.

According to this configuration, the binding property of the solid electrolyte in the solid electrolyte layer can be further enhanced, achieving densification and enhanced ionic conductivity of the solid electrolyte layer.

### (Technique 21)

The battery according to Technique 20, wherein
the second halide solid electrolyte has a lower melting point than the first halide solid electrolyte.

Accordingly, in manufacturing the solid electrolyte layer (e.g., during pressing for lamination), the second halide solid electrolyte, which has higher softness owing to its low melting point, tends to deform and fill the gaps between the first halide solid electrolytes. This facilitates densification of the solid electrolyte layer. In commonly used hot pressing, the second halide solid electrolyte having a low melting point exhibits particularly increased deformability. Densification enhances the ionic conductivity in the solid electrolyte layer, suppressing structural defects (e.g., voids or cracks). Fine voids and cracks, which serve as starting points where degradation of the properties becomes apparent due to external stress and thermal cycling, are reduced, and accordingly, a solid electrolyte layer having high reliability can be obtained. Therefore, a battery having excellent performance and excellent reliability can be achieved.

### (Technique 22)

The battery according to Technique 20 or 21, wherein
the second halide solid electrolyte is softer than the first halide solid electrolyte.

Accordingly, in manufacturing the solid electrolyte layer (e.g., during pressing for lamination), the second halide solid electrolyte, which has higher softness, tends to deform and fill the gaps between the first halide solid electrolytes. This facilitates densification of the solid electrolyte layer. Densification enhances the ionic conductivity in the solid electrolyte layer, suppressing structural defects (e.g., voids or cracks). Fine voids and cracks, which serve as starting points where degradation of the properties becomes apparent due to external stress and thermal cycling, are reduced, and accordingly, a solid electrolyte layer having high reliability can be obtained. Therefore, a battery having excellent performance and excellent reliability can be achieved. The comparison in softness between the second halide solid electrolyte and the first halide solid electrolyte can be evaluated, for example, by a method such as the micro Vickers method.

### (Technique 23)

The battery according to any one of Techniques 20 to 22, wherein
the second halide solid electrolyte includes a crystalline phase represented by the following composition formula (4):

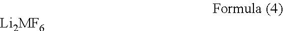

in the composition formula (4), the M is at least one element selected from the group consisting of metal elements each having a valence of four and metalloid elements each having a valence of four.

Accordingly, the second halide solid electrolyte, which is softer than the first halide solid electrolyte, can be used. This facilitates densification of the solid electrolyte layer. This enhances the ionic conductivity in the solid electrolyte layer, suppressing structural defects (e.g., voids or cracks). Fine voids and cracks, which serve as starting points where degradation of the properties becomes apparent due to external stress and thermal cycling, are reduced, and accordingly, a solid electrolyte layer having high reliability can be obtained. Therefore, a battery having excellent performance and excellent reliability can be achieved.

### (Technique 24)

The battery according to Technique 23, wherein
the M includes Ti.

This increases the ionic conductivity of the second halide solid electrolyte to a level comparable to that of the first halide solid electrolyte (e.g., 1 μS/cm or more). Accordingly, a solid electrolyte layer having high ionic conductivity and high reliability can be obtained. Therefore, a battery having excellent performance and excellent reliability can be obtained.

The battery according to the present disclosure has been described based on the embodiments; however, the present disclosure is not limited to these embodiments. Various modifications of the embodiments conceivable by those skilled in the art and other embodiments achieved by combining some of the constituents of the embodiments also fall within the scope of the present disclosure without departing from the spirit of the present disclosure.

Furthermore, the above embodiments may undergo various modifications, replacements, additions, omissions, and the like within the scope of the claims or equivalents thereof.

### INDUSTRIAL APPLICABILITY

The battery according to the present disclosure can be used, for example, as a secondary battery such as an all-solid-state battery or a liquid battery for use in various electronic devices, automobiles, and the like.

What is claimed is:

1. A battery comprising:
a first electrode layer;
a second electrode layer; and
an electrolyte layer disposed between the first electrode layer and the second electrode layer, wherein
the battery satisfies at least one configuration selected from the group consisting of the following (I) and (II):
(I) at least one selected from the group consisting of the first electrode layer, the second electrode layer, and the electrolyte layer comprises an Al halide; and
(II) the battery further comprises a side surface layer, the side surface layer being disposed on a side surface of at least one layer selected from the group consisting of the first electrode layer, the second electrode layer, and the electrolyte layer, the side surface layer comprising an Al halide, and
the Al halide is represented by the following composition formula (1): 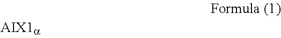
in the composition formula (1), the X1 is at least one selected from the group consisting of F, Cl, Br, and I, and the α satisfies 2.95≤α≤3.05.

2. The battery according to claim 1, wherein
the electrolyte layer is a solid electrolyte layer.

3. The battery according to claim 2, wherein
the solid electrolyte layer comprises a halide solid electrolyte.

4. The battery according to claim 1, wherein
the electrolyte layer is composed of an electrolyte solution and a separator impregnated with the electrolyte solution.

5. The battery according to claim 1, wherein
the battery satisfies the (I),
at least one selected from the group consisting of the first electrode layer, the second electrode layer, and the electrolyte layer comprises a solid electrolyte particle and a coating layer coating at least a portion of a surface of the solid electrolyte particle, and
the coating layer comprises the Al halide.

6. The battery according to claim 1, wherein
the battery satisfies the (I),
at least one selected from the group consisting of the first electrode layer, the second electrode layer, and the electrolyte layer comprises a solid electrolyte particle, and
the Al halide is contained within the solid electrolyte particle.

7. The battery according to claim 1, wherein
the battery satisfies the (I),
at least one selected from the group consisting of the first electrode layer and the second electrode layer comprises an active material particle and a coating layer coating at least a portion of a surface of the active material particle, and
the coating layer comprises the Al halide.

8. The battery according to claim 1, wherein
the Al halide is in particulate form.

9. The battery according to claim 1, wherein
the Al halide comprises AlF₃.

10. The battery according to claim 9, wherein
the AlF₃ has an orthorhombic crystal structure.

11. The battery according to claim 10, wherein
the AlF₃ is in particulate form, and
at least a portion of a surface of a particle of the AlF₃ is coated with a coating layer comprising a solid electrolyte.

12. The battery according to claim 9, wherein
the AlF₃ comprises a first crystalline phase having an orthorhombic crystal structure and a second crystalline phase having a trigonal crystal structure.

13. The battery according to claim 12, wherein
the AlF₃ is in particulate form,
in a surface region of a particle of the AlF₃, a content of the first crystalline phase is greater than a content of the second crystalline phase, and
in an inner region of the particle of the AlF₃, the content of the second crystalline phase is greater than the content of the first crystalline phase.

14. The battery according to claim 12, wherein
the AlF₃ is in particulate form, and
at least a portion of a surface of a particle of the AlF₃ is coated with a coating layer comprising a solid electrolyte.

15. The battery according to claim 9, wherein
the Al halide comprises AlF₃ in particulate form, and
particles of the AlF₃ comprise:
a first particle formed of AlF₃ having an orthorhombic crystal structure; and
a second particle comprising a first crystalline phase having an orthorhombic crystal structure and a second crystalline phase having a trigonal crystal structure.

16. The battery according to claim 15, wherein
an average particle diameter of the second particles is larger than an average particle diameter of the first particles.

17. The battery according to claim 3, wherein
the halide solid electrolyte comprises Al.

18. The battery according to claim 17, wherein
the halide solid electrolyte comprises a first halide solid electrolyte comprising a crystalline phase represented by the following composition formula (2): 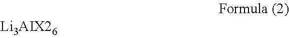
in the composition formula (2), the X2 is at least one selected from the group consisting of F, Cl, Br, and I.

19. The battery according to claim 18, wherein
the first halide solid electrolyte comprises a crystalline phase represented by the following composition formula (3):

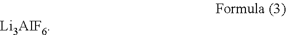

20. The battery according to claim 18, wherein
the halide solid electrolyte further comprises a second halide solid electrolyte having a composition different from a composition of the first halide solid electrolyte.
